(19) United States
(12) Patent Application Publication
(10) Pub. No.: US 2006/0205462 A1
(43) Pub. Date: Sep. 14, 2006

(54) Video games, characters and rosters

(76) Inventors: William G. Bentz, Laurel, MD (US); Gonzalo F. Valdes, Tampa, FL (US)

Correspondence Address: William G. Bentz, 8106 Shannon's Alley, Laurel, MD, 20724, US

(21) Appl. No.: 11/120,936

(22) Filed: May 4, 2005

Related U.S. Application Data
(63) Continuation-in-part of application No. 11/078,664, filed on Mar. 14, 2005.

(51) Int. Cl. A63F 13/00

(52) U.S. Cl. 463/2

(57) ABSTRACT

One embodiment of a method may display information identifying at least (i) a plurality of video games and (ii) a plurality of characters and/or rosters. The method may individually sell and/or rent the video games, and individually sell and/or rent, separate from the video games, the characters and/or the rosters to import into one or more of the video games.

This application is a continuation-in-part of Ser. No. 11/078,664, filed Mar. 14, 2005.

### FIELD OF THE INVENTION

The present invention relates in general to (i) video games, (ii) characters (e.g., of different video games and/or others) and/or (iii) rosters (e.g., of different sports teams and/or others).

### DESCRIPTION OF BACKGROUND INFORMATION

The video game industry is a growing multi billion dollar industry. Electronic Arts' Madden NFL Football has been recognized as the most popular sports video game ever. Electronic Arts has compared the Madden NFL Football game to an ever-evolving novel, with a new chapter being written every year. Electronic Arts, as a leading developer and publisher of interactive entertainment software, has emphasized the need to continue to take a video game and its users to new heights. Accordingly, new ways are needed to enhance a user's game experience.

### BRIEF DESCRIPTION OF THE DRAWINGS

In the drawings, like reference numerals represent similar parts of the illustrated embodiments of the present invention throughout the several views and wherein:

FIGS. 1A, 1B, 1C, 1D and 2-6 depict exemplary embodiments of methods; and

FIGS. 7-9 depict exemplary embodiments of games.

### DETAILED DESCRIPTION

One embodiment of a method may provide, through a first video game, one or more athletes and/or team rosters, for example, including the one or more athletes. The method may play, through a second video game, a game with at least the one or more athletes by importing the one or more athletes and/or team rosters from the first video game to the second video game. The first video game and the second video game may be of different sports. The method may allow video game companies such as, for example, Electronic Arts to integrate some and/or all of their sports games and/or other categories of games. The method may also allow gamers to try to determine (e.g., year after year) who is the best athlete and/or team in the world, for example, by playing one or more sports video games with athletes and/or teams outside their specialties.

Another embodiment of the method may display information identifying at least (i) a plurality of video games (e.g., and others) and (ii) a plurality of characters and/or rosters (e.g., and others). The method may individually sell and/or rent the video games, and individually sell and/or rent, separate from the video games, the characters and/or rosters to import into one or more of the video games. The method may provide (e.g., mail and/or download) the characters and/or rosters to import into the one or more of the video games. The method may charge for the characters and/or rosters on a per character and/or roster basis, for example, plus provide personal use rights.

Each of the characters and/or rosters may be of a first category of video games, and each of the video games may be of a second category of video games, where the first category and the second category may be different categories. Each of the characters and/or rosters may also be of a first video game of a first sport, and the one or more of the video games may include a second video game of a second sport, where the first sport and the second sport may be different sports.

In addition, the characters and/or rosters may include a plurality of first characters and/or rosters and a plurality of second characters and/or rosters. Each of the plurality of first characters and/or rosters may be of a first category of video games, and each of the plurality of second characters and/or rosters may be of a second category of video games, where the first category and the second category may be different categories. The one or more of the video games may fall under one of (i) the first category of video games and (ii) the second category of video games. The one or more of the video games, for example, may include a sports video game.

Further, the characters and/or rosters may include a plurality of first characters and/or rosters, a plurality of second characters and/or rosters and a plurality of third characters and/or rosters. Each of the plurality of first characters and/or rosters may be of a first video game of a first sport, each of the plurality of second characters and/or rosters may be of a second video game of a second sport, and each of the plurality of third characters and/or rosters may be of a third video game of a third sport, where each of the first sport, the second sport and the third sport may be different sports. For example, the first sport may be football, the second sport may be basketball, and the third sport may be baseball. The one or more of the video games may include a fourth video game of a fourth sport, where the fourth sport may be different than each of the first sport, the second sport and the third sport. The fourth sport may be football, basketball or baseball.

The method may then provide video game companies a way to add new revenue streams and, also, a way to add new dimensions to their video games. The method, for example, may allow gamers to buy individual characters and/or rosters (e.g., of one or more video games and/or others) they like and want to own to import, for example, into a plurality of different video games, so as to play the video games with at least the individual characters and/or rosters.

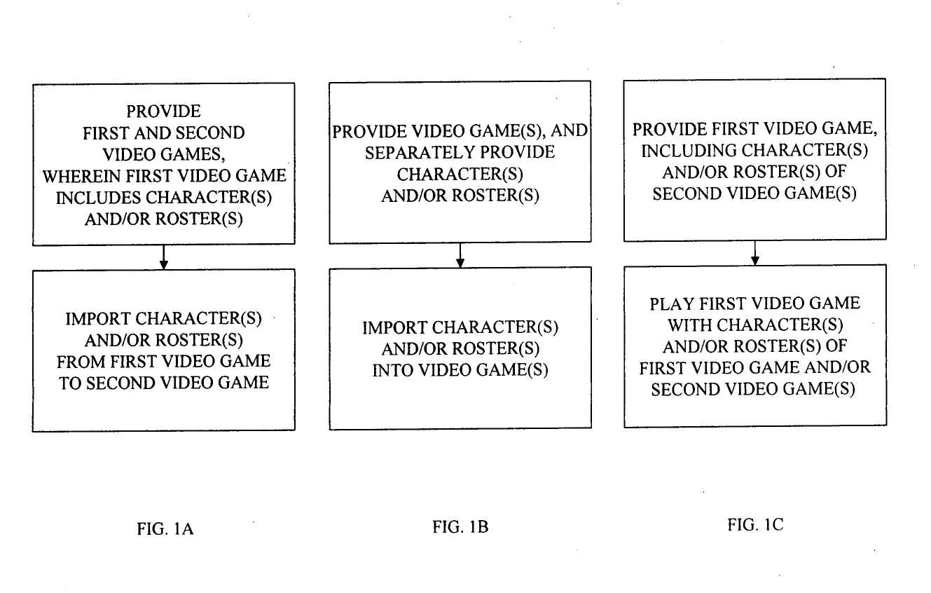

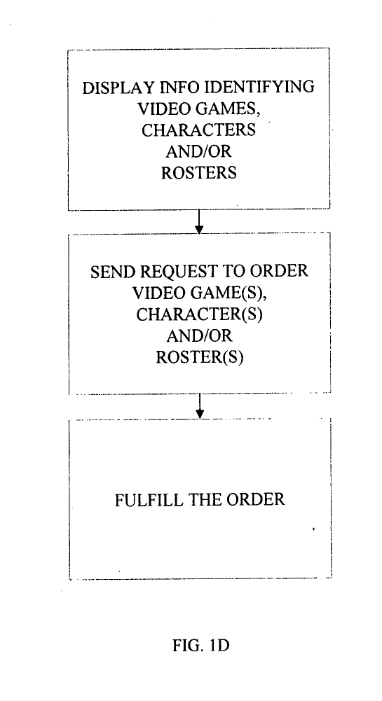

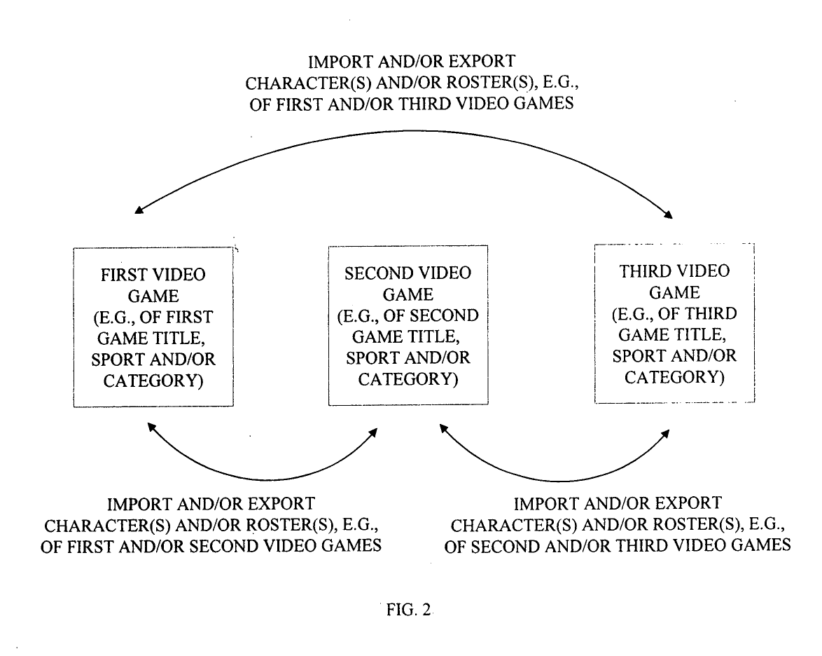

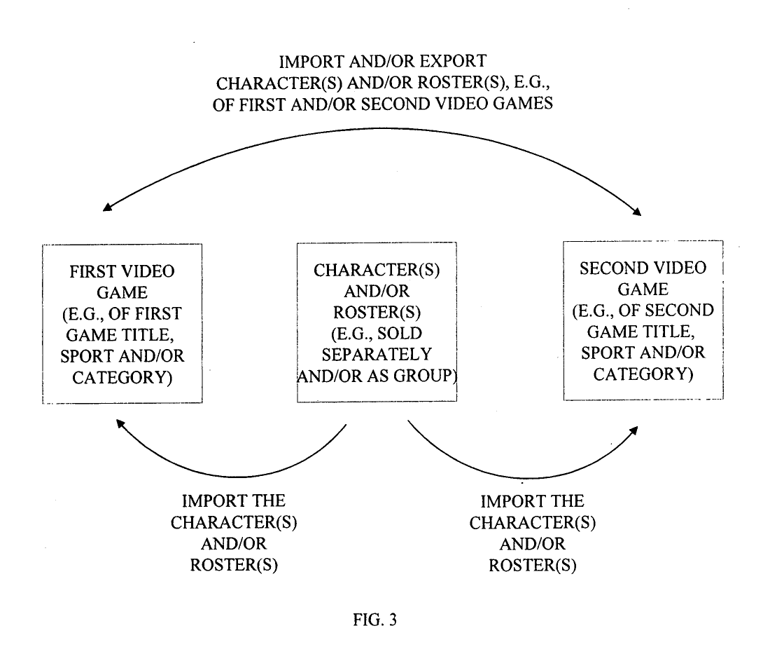

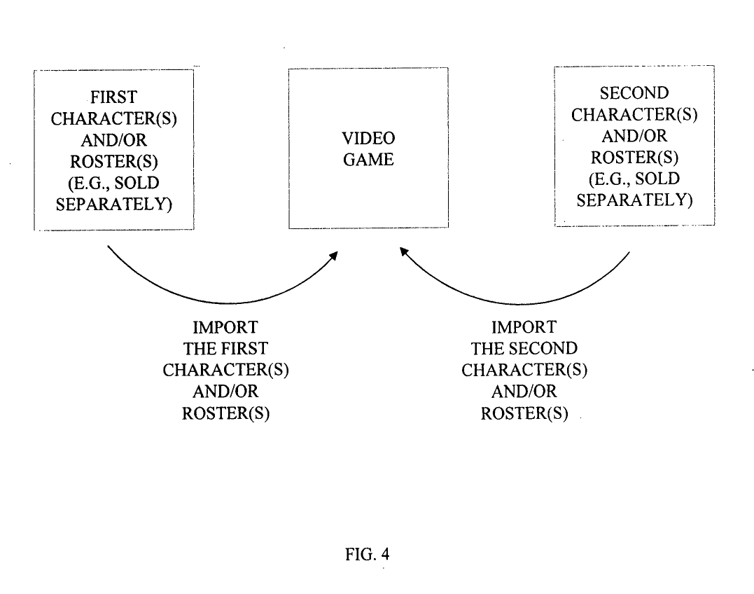

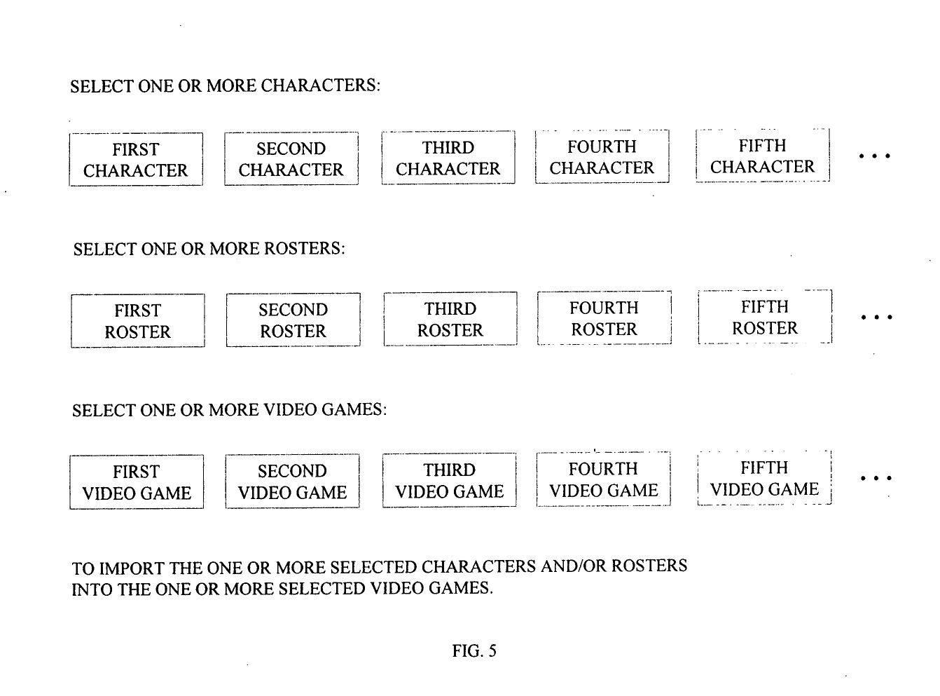

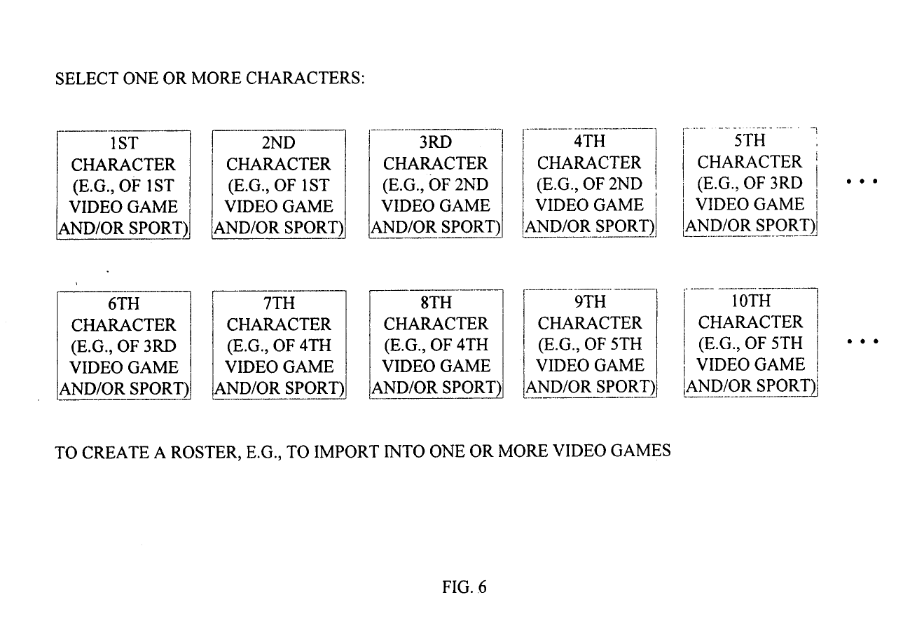

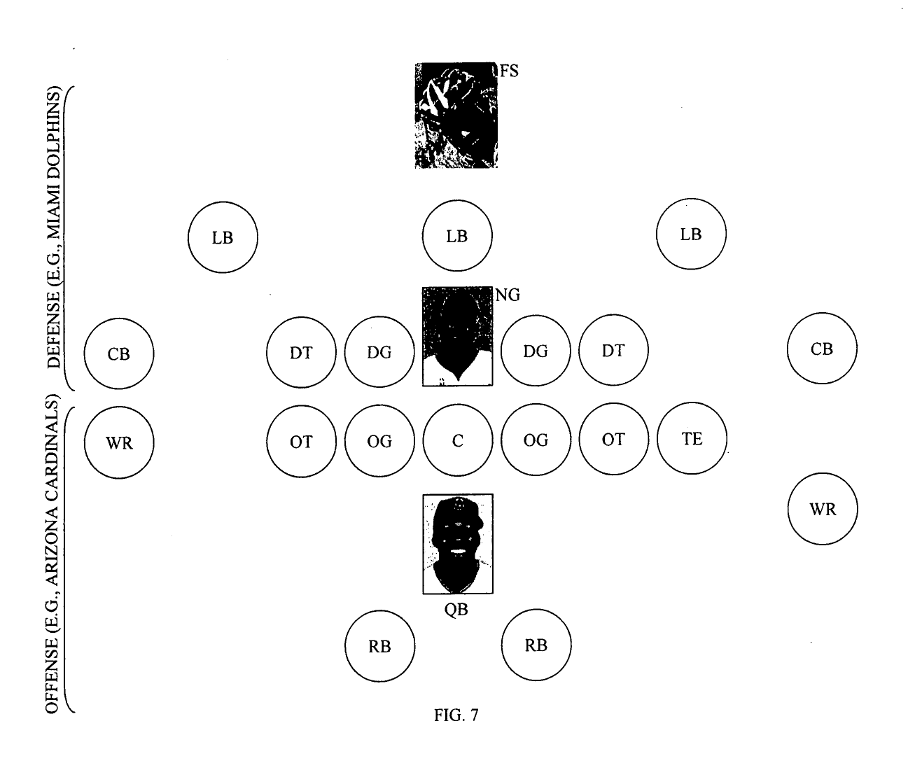

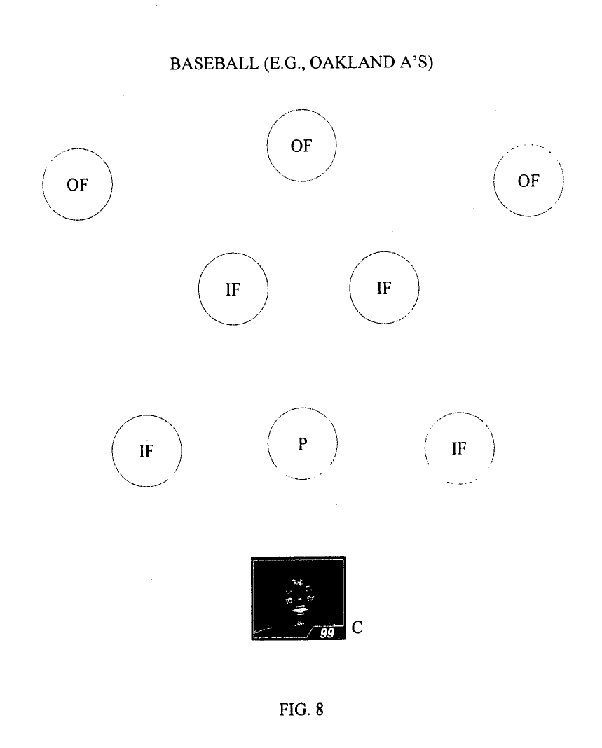

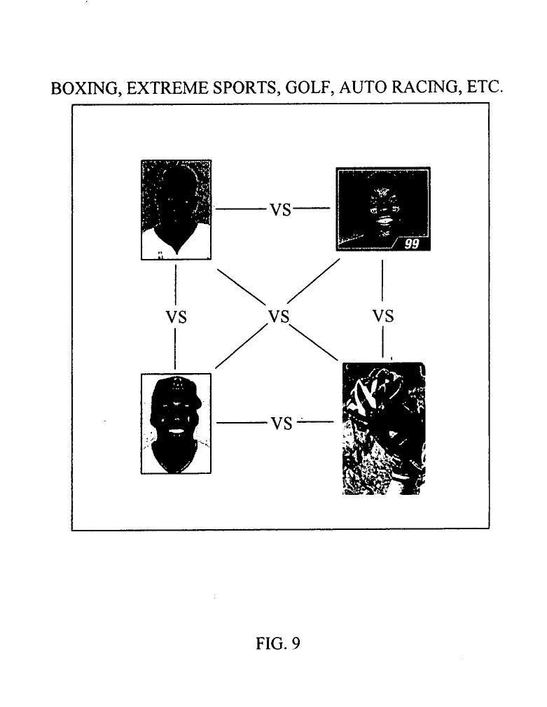

An exemplary combination of the method (see, for example, FIGS. 1-9) may also include one or more of the following:
A method may provide at least a character(s) of a first video game. The method may play a second video game with at least the character(s) by importing the character(s) (e.g., from the first video game) into the second video game. The first video game and the second video game may or may not be of different sports and/or different categories of video games;
A method may provide a video game with a plurality of athletes of different sports video games. The method may play the video game with one or more of the athletes by at least selecting the one or more of the athletes;
A method may provide a video game with a plurality of teams of different sports video games. The method may play the video game with one or more rosters of one or more of the teams by at least selecting the one or more of the teams;
A method may provide, through a video game, a pool including athletes and/or teams of different sports. The method may play, through the video game, a game with at least one or more of the athletes and/or teams by at least selecting the one or more of the athletes and/or teams from the pool. Each of the teams may include a roster. The method may add, through the video game, one or more of the athletes to one or more of the team rosters. The team rosters may be associated with a first sport, and the athletes may be associated with a second sport. The game may be the first sport or the second sport;
A method may provide, through a first video game, at least a first team roster and, through a second video game, at least a second team roster. The method may play, through the second video game, a game with at least the first team roster and/or the second team roster by importing the first team roster (e.g., from the first video game) into the second video game. The first video game and the second video game may or may not be of different sports and/or leagues. One of the first team roster and the second team roster, for example, may be a team of a professional sports league (e.g., NFL Football, NBA Basketball, etc.), and the other one of the first team roster and the second team roster may be a team of an amateur sports league (e.g., NCAA Football, NBA Basketball);
A method may provide, through a first video game, at least one or more pro athletes and, through a second video game, at least one or more amateur athletes. The method may play the second video game with at least the one or more pro athletes and/or the one or more amateur athletes by importing the one or more pro athletes (e.g., from the first video game) into the second video game. The first video game may be professional football and the second video game may be college football. The first video game may also be professional basketball and the second video game may also be college basketball;
A method may provide pro athletes of a first video game and amateur athletes of a second video game. The method may play the second video game with one or more of the pro athletes and/or one or more of the amateur athletes by importing the pro athletes (e.g., from the first video game) into the second video game;
A method may provide, through a video game, a pool including pro athletes and college teams. The method may add, through the video game, one or more of the pro athletes to one or more of the college teams, for example, by using the pool. The method may play, through the video game, a game by using the one or more of the college teams;
A method may provide, through a first video game, at least one or more first characters and, through a second video game, at least one or more second characters. The method may play a third video game with at least one of (i) the one or more first characters and (ii) the one or more second characters by importing (i) the one or more first characters (e.g., from the first video game) into the third video game and (ii) the one or more second characters (e.g., from the second video game) into the third game. The first, second and/or third video games may be different games and/or categories. A first sports team roster may be made up of the one or more first characters and/or other characters, and a second sports team roster may be made up of the one or more second characters and/or other characters;
A method may provide a plurality of first athletes of a first video game and a plurality of second athletes of a second video game. The method may play a third video game with at least one of (i) one or more of the first athletes and (ii) one or more of the second athletes by importing at least (i) the one or more of the first athletes into the third video game and (ii) the one or more of the second athletes into the third game. Each of the first video game, the second video game and the third video game may be of different sports;
A method may provide, through a first video game, at least one or more characters. The method may play a second video game with at least the one or more characters by importing the one or more characters (e.g., from the first video game) to the second video game. The first video game and the second video game may be of different categories;
A method may display, through a store, information identifying at least a character and/or roster of a first video game to import into at least a second video game. The method may individually sell and/or rent, through the store, the character and/or roster, separate from the first video game and the second video game, by at least charging on a per character and/or roster basis. The store may be an online and/or offline store. The first video game may be of a first category of video games, and the second video game may be of a second category of video games, where the first category and the second category may be different categories. The first video game may also be of a first sport, and the second video game may be of a second sport, where the first sport and the second sport may be different sports;
A method may display information identifying at least a character and/or roster. The method may sell and/or rent the character and/or roster itself to import into a first video game, and may separately sell and/or rent the character and/or roster itself to import into a second video game, where the first video game and the second video game may have different game titles and be playable with the same platform. The method may provide (e.g., mail and/or download) the character and/or roster to import into at least one of (i) the first video game and (ii) the second video game. The first video game and the second video game may be of different categories of video games. The first video game and the second video game may also be of different sports;
A method may display information identifying different athletes of video games of different sports. The method may send a request to order a roster(s) to import into one or more of the video games by at least selecting a plurality of the athletes for the roster. The method may fulfill the order for the roster(s) by at least receiving the request for the order. The video games of different sports, for example, may include (i) a football video game, (ii) a basketball video game and (iii) a baseball video game;
A method may display information identifying at least (i) a plurality of different characters and/or rosters (e.g., and others) and (ii) a plurality of different video games (e.g., and others). The method may send a request to order at least one or more of the characters and/or rosters to import into one or more of the video games by at least selecting (i) the one or more of the characters and/or rosters and/or (ii) the one or more of the video games. The method may fulfill the order for the one or more of the characters and/or rosters by at least receiving the request for the order. Each of the characters and/or rosters may be of a first category of video games, and each of the video games may be of a second category of video games, where the first category and the second category may be different categories. Each of the characters and/or rosters may also be of a first video game of a first sport, and the one or more of the video games may include a second video game of a second sport, where the first sport and the second sport may be different sports. The video games may further include different categories of video games;
A method may display information identifying at least a plurality of different characters and/or rosters (e.g., and others) to import into a plurality of different video games (e.g., and others). The method may send a request to order one or more of the characters and/or rosters by at least selecting (e.g., individually selecting) the one or more of the characters and/or rosters from the plurality of different characters and/or rosters. The method may fulfill the order for the one or more of the characters and/or rosters to import into one or more of the video games by at least receiving the request for the order. The order may be fulfilled to complete a purchase, rental and/or trade for the one or more of the characters and/or rosters to import into the one or more of the video games. The method may charge for the plurality of different characters and/or rosters on a per character and/or roster basis. The method may download and/or mail the one or more of the characters and/or rosters to import into the one or more of the video games. Each of the plurality of different characters and/or rosters may be of a first category of video games, and each of the plurality of different video games may be of a second category of video games, where the first category and the second category may be different categories. Each of the plurality of different characters and/or rosters may also be of a first video game of a first sport, and the one or more of the video games may include a second video game of a second sport, where the first sport and the second sport may be different sports. The plurality of different characters and/or rosters may further be of (i) different categories of video games and/or (ii) video games of different sports;
A method may display information identifying at least (i) a first character and (ii) a second character. The method may sell, rent and/or trade for the first character itself to import into a video game, and separately sell, rent and/or trade for the second character itself to import into the video game. The first character and the second character may be different characters. The method may charge for the first and second characters on a per character basis. The method may download and/or mail the first character and/or the second character to import into the video game. The first character may be of a first category of video games, and the second character may be of a second category of video games, where the first category and the second category may be different categories. The first character may also be of a first sport, and the second character may be of a second sport, where the first sport and the second sport may be different sports. The different characters may be of different video games. The different characters may be of a second video game, where the first-mentioned video game and the second video game may be different video games; and/or
A method may display information identifying at least (i) a first roster and (ii) a second roster. The method may sell, rent and/or trade for the individual first roster to import into a video game, and separately sell, rent and/or trade for the individual second roster to import into the video game. The first roster and the second roster may be different rosters. The method may charge for the first and second rosters on a per roster basis. The method may download and/or mail the first roster and/or the second roster to import into the video game. The first roster may be of a first category of video games, and the second roster may be of a second category of video games, where the first category and the second category may be different categories. The first roster may also be of a first sport, and the second roster may be of a second sport, where the first sport and the second sport may be different sports. The different rosters may be of different video games. The different rosters may be of a second video game, where the first-mentioned video game and the second video game may be different video games.

The sport(s) and/or video game(s) such as, for example, the first sport and/or video game may be: football, basketball, baseball, boxing, wrestling, martial arts, skateboarding, surfing, rock climbing, skiing, ski jumping, bobsledding, luge, extreme sports, water sports, soccer, hockey, rugby, cricket, lacrosse, volleyball, tennis, golf, auto racing, motor sports, track and field, gymnastics, water polo, swimming, speed skating, ice skating, roller skating, diving, rowing, archery, kayak, olympic sports, table tennis, cycling, weight-lifting, water skiing, fishing, shooting, bowling, horse racing, billiards, rodeo, cheerleading and/or poker, and the second sport and/or video game and/or the third sport and/or video game (e.g., and others) may be a different one. The sports and/or video games may also be any other known sport and/or game.

The characters(s) (e.g., one or more athletes) and/or roster(s), and the pool (e.g., a list, a group, etc.) including the characters (s) and/or roster(s) may be associated with football, basketball, baseball, boxing, wrestling, martial arts, skateboarding, surfing, rock climbing, skiing, ski jumping, bobsledding, luge, extreme sports, water sports, soccer, hockey, rugby, cricket, lacrosse, volleyball, tennis, golf, auto racing, motor sports, track and field, gymnastics, water polo, swimming, speed skating, ice skating, roller skating, diving, rowing, archery, kayak, olympic sports, table tennis, cycling, weight-lifting, water skiing, bowling, horse racing and/or rodeo. The character(s), roster(s) and/or pool, for example, may include (i) a plurality of active NFL All-Pro players, (ii) a plurality of active NBA All-Star players and/or (iii) a plurality of active MLB All-Star players. The character(s), roster(s) and/or pool may also include (i) a plurality of retired NFL All-Pro players, (ii) a plurality of retired NBA All-Star players and/or (iii) a plurality of retired MLB All-Star players. The character(s), roster(s) and/or pool may further include some and/or all NFL, NBA, MLB, PGA, NHL, MLS, and/or NASCAR players (e.g., active and/or retired) and/or rosters.

The one or more characters (e.g., athletes and/or others) and/or team rosters may be selected from the pool, for example, by (i) scrolling through the pool, (ii) highlighting the one or more characters and/or teams and (iii) pressing a button of a controller. The one or more characters, for example, may be selected from the pool to be added to a roster. Also, the one or more characters (e.g., athletes and/or others) and/or team rosters may be imported, through a machine-readable-medium (e.g., memory card), into the second video game, for example, as it is known to import an entire draft class from Electronic Arts' NCAA Football to Madden NFL Football via a memory card. The method may provide a draft for the one or more characters. The method may also allow roster moves such as, for example, trade players, sign players, and/or release players to be made to strengthen a lineup. Injuries and/or demands by the one or more athletes from one sport (e.g., the first video game) may be carried forward to another sport (e.g., the second video game).

The character(s), for example, may include one or more athletes, coaches, managers, team owners, sports agents, promoters, announcers, commentators, icons, stars (e.g., movie stars, television stars, rock stars and/or others), superheroes, cartoon characters, animated characters, action figures, actors, politicians, musicians, entertainers, celebrities, comedians, and/or business people. The character(s), for example, may also include (i) public and/or private figures, (ii) pop icons and/or (iii) famous, infamous and/or ordinary people. The character(s) may include video game characters such as, for example, Ben Rothlisberger (of Madden NFL Football), Psymon (of SSX Tricky), Nick Kang (of True Crime), Raiden (of Mortal Kombat) and/or SpongeBob (of SpongeBob).

The one or more athletes may include professional, amateur and/or fictional athletes, which may be active and/or retired. The one or more athletes may also be single-sport or multi-sport athletes. The one or more team rosters may be associated with (e.g., be a part of) professional, amateur and/or fictional sports leagues such as, for example, NFL, NBA, MLB, NHL, MLS and/or NCAA. The one or more athletes and/or team rosters may include Lou Gehrig, Gordie Howe, Michael Jordan, Jackie Robinson, Rafer Johnson, Wilt Chamberlain, Bo Jackson, Dave Winfield, Jim Thorpe, Jim Brown, Muhammad Ali, Pele, Lance Armstrong, Andre Agassi, Randy Johnson, Shaquille O'Neal, Vladimir Guerrero, LeBron James, Warren Sapp, Andy Roddick, David Beckham, Tracy McGrady, Michael Vick, Kevin Garnett, Kobe Bryant, Tim Montgomery, Simeon Rice, Ray Lewis, Tony Gonzalez, Peter Forsberg, Tiger Woods, Tony Hawk, Artus Taymazov, Michael Phelps, Kelly Slater, Freddy Adu, Jonny Wilkinson, Paul Hamm, Thierry Henry, Allen Iverson, Terrell Owens, Jason Kidd, Brian Urlacher, Alex Rodriguez, Ichiro Suzuki, Sergei Fedorov, Barry Bonds, Roger Federer, Zinedine Zidane, Tim DeBoom, Jeremy Bloom, Roy Jones Jr., Peter Reid and/or Tom Pappas.

A performance of the one or more characters (e.g., athletes) and/or team rosters may be enhanced to play a game by putting the one or more characters and/or team rosters through one or more drills and/or pre-season games. The drills may include performing certain plays, runs, and/or passes, and may be part of a training camp.

The general categories of video games may include simulations of sports, simulations of military actions, games inspired by cinema, electronic versions of traditional games (e.g. cards), simulations of actions in the framework of a certain profession (e.g. physician), and specific games not appealing to reality. The categories of video games, for example, may include action, adventure, children's, driving (e.g., racing), fighting, first person (e.g., shooting), puzzle, role-playing, simulation, sports, strategy and/or card/casino games.

An exemplary embodiment of the method (e.g., a service) may allow users to search, preview, buy, download and/or recommend at least individual characters and/or rosters (e.g., of video games and/or others) to import into one or more video games. The method may allow the users to browse by and/or enter a search for at least (i) video game categories, (ii) video game titles and/or (iii) characters and/or rosters. The method may provide previews of items, for example, by double-click on listings. The method may provide the users a shopping cart to hold their selections until the users are ready to buy. The method may allow users to buy at least individual characters and/or rosters, for example, with just one click. (See, for example, U.S. Pat. No. 5,960,411, which is hereby incorporated by reference.) The method may provide (e.g., mail and/or download) the selected characters and/or roster to a machine-readable-medium (e.g., memory card) to import into the one or more video games.

The method may also determine a user's interests by examining, in part or in whole, the items (e.g., video games, characters and/or rosters) purchased, items the user has indicated he or she owns, and/or items the user has rated. The method may compare the user's activity on a site of the service with that of other customers. Using this comparison, the method may recommend other items (e.g., video games, characters and/or rosters) that may interest the user. The recommendations may change when the user purchases or rates a new item. Changes in the interests of other customers may also affect the user's own recommendations. (See, for example, U.S. Pat. No. 6,853,982, which is hereby incorporated by reference.)

When rating an item (e.g., video games, characters and/or rosters), the method may provide a star scale, for example, as follows: 1 star: I hate it; 2 stars: I don't like it; 3 stars: It's OK; 4 stars: I like it; and 5 stars: I love it. These ratings may be used by the recommendations service to provide the user more accurate recommendations.

The service (e.g., an online and/or offline service) may thus sell, rent and/or trade individual video games, characters (e.g., of video games and/or others) and/or rosters (e.g., of sports teams and/or others), and may charge a monthly fee and/or charge on a per item basis such as, for example, pay for what you buy and/or rent, and no more.

One embodiment of the service may allow users to place an order for at least individual characters and/or rosters to import into one or more video games, for example, as follows:

1. Find the Items You Want;

2. Add the Items to Your Shopping Cart;

3. Proceed to Checkout;

4. Sign In;

5. Enter a Shipping Address;

6. Choose a Shipping Method;

7. Provide a Password and Payment Information;

8. Review and Submit Your Order; and/or

9. Check Your Order Status,

Find the Items You Want

You may browse or search for the items you would like to order. When you find an item that interests you, click the title or name of the item to see its product detail and/or preview page. Here you will find more information about the item, including an availability estimate of how long it will take before the item will be ready to be shipped and/or downloaded.

Add the Items to Your Shopping Cart

If you want to order an item, click the “Add to Shopping Cart” button on the item's product detail page. Once you've added an item to your Shopping Cart, use the cart's navigation bar or the “Continue shopping” button to keep searching or browsing until your cart contains all of the items you want to order. You can access the contents of your Shopping Cart at any time by clicking the Shopping Cart icon at the Web site.

Proceed to Checkout

You may review all of the items placed in your Shopping Cart. If you decide that you don't want to purchase a particular item right away, click the “save for later” button. The item will move from your current Shopping Cart to the “Saved Items—To Buy Later” list. When you're ready to place an order for everything in the “Shopping Cart Items—To Buy Now” section of your cart, click the “Proceed to checkout” button. You will be taken to the first page of the order form.

The instructions for an online order form may include:

Sign In

Enter your e-mail address, indicate that you are a new customer, and click the “Sign in” button. You may be asked to provide a password for your account later in the process.

Enter a Shipping Address

Tell us where you would like to ship your order, and let us know if any of the items are to be gifts. If so, you'll be given a chance to order gift-wrap and add a note.

Choose a Shipping Method

Consider how quickly you would like to receive your order, and choose a shipping method.

We will estimate shipment dates for you on the order form, just before you submit your order. You will see estimated shipment and delivery dates in an e-mail we send you to confirm your order.

If there is more than one item in your order, you may be given the following options:
Group my items into as few shipments as possible
I want my items faster. Ship them as soon as they become available (e.g., at additional cost)

If you choose the first option, we'll consolidate your items into the fewest shipments possible. We'll show you the minimum number of shipments needed to complete your order. If you choose the second option, we will ship items to you as they become available, beginning with those already in stock. You'll be charged a per-shipment fee for each shipment.

The shipping charge for your order will be displayed on the order summary page just before you submit your order.

Provide a Password and Payment Information

Choose a password for your account so that when you come back to the web site in the future, you can use the same shipping address and method of payment you provided during this first order. You will also be able to use your password to make changes to your order and account information.

Next, let us know how you would like to pay for your order.

Review and Submit Your Order

Check the accuracy all of the information you provided and make any necessary adjustments. When you are ready, click the Place Your Order button to submit your order. Once you place your order, we will send you a confirmation e-mail message. We will send you another e-mail message at the time of shipment. We may also turn 1-Click shopping on for you so that it's even easier to order in the future.

Check Your Order Status

If you would like to review or change something about the order you placed before it enters the shipping process, click the Your Account link in the site. Here you will be able to change the particulars of your order.

The character(s), roster(s) and/or video game(s) (e.g., of one or more described embodiments) may be playable by consumers on platforms including personal computers and/or entertainment systems (e.g., consoles and/or handhelds) such as, for example, Sony PlayStation2, Sony PlayStation, Microsoft Xbox, Nintendo GameCube, Game Boy Advance and/or N-Gage. The platforms may also include online, over the Internet and/or other online networks. The handhelds may include cell phones.

A user, for example, may use X-Port, SharkPort and Action Replay, as sold at retail or game specialty stores, to download characters and/or rosters. The user may also select a memory card with characters and/or rosters to be mailed.

Unlike buying a video game, where gamers would have to pay for the whole video game to get the one or two characters and/or rosters they really want, an embodiment of the method may allow gamers to buy only the characters and/or rosters they like and want to own, so as to import into one or more other video games. The method may also allow gamers to (i) buy characters and/or rosters that, for example, video games themselves do not include and/or (ii) mix and match characters and/or team rosters, for example, of different video game titles, video game categories and/or sports.

A machine-readable medium having encoded information, which when read and executed by a machine causes, for example, a method (e.g., one or more described embodiments). The machine-readable medium may store programmable parameters and may also store information including executable instructions, non-programmable parameters, and/or other data. The machine-readable medium may comprise read-only memory (ROM), random-access memory (RAM), nonvolatile memory, an optical disk, a magnetic tape, and/or magnetic disk. The machine-readable medium may further include, for example, a carrier wave modulated, or otherwise manipulated, to convey instructions that can be read, demodulated/decoded and executed by the machine (e.g., one or more of the platforms). The machine may comprise one or more microprocessors, microcontrollers, and/or other arrays of logic elements.

In view of the foregoing, it will be apparent to one of ordinary skill in the art that the described embodiments may be implemented in software, firmware, and/or hardware. The actual software code or specialized control hardware used to implement the described embodiments is not limiting of the invention. Thus, the operation and behavior of the embodiments is described without specific reference to the actual software code or specialized hardware components. The absence of such specific references is feasible because it is clearly understood that artisans of ordinary skill would be able to design software and/or control hardware to implement the embodiments based on the description herein.

The foregoing presentation of the described embodiments is provided to enable any person skilled in the art to make or use the present invention. Various modifications to these embodiments are possible, and the generic principles presented herein may be applied to other embodiments as well. As such, the present invention is not intended to be limited to the embodiments shown above, any particular sequence of acts, and/or any particular configuration of hardware but rather is to be accorded the widest scope consistent with the principles and features disclosed in any fashion herein.

What is claimed is:

1. A method comprising:
displaying information identifying at least (i) a plurality of video games and (ii) a plurality of characters; and
individually selling and/or renting the video games, and individually selling and/or renting, separate from the video games, the characters to import into one or more of the video games.

2. The method of claim 1, further comprising
charging for the characters on a per character basis.

3. The method of claim 1, further comprising
downloading the characters to import into the one or more of the video games.

4. The method of claim 1,
wherein each of the characters is of a first category of video games,
wherein each of the video games is of a second category of video games, and
wherein the first category and the second category are different categories.

5. The method of claim 1,
wherein each of the characters is of a first video game of a first sport,
wherein the one or more of the video games includes a second video game of a second sport, and
wherein the first sport and the second sport are different sports.

6. The method of claim 1,
wherein the characters includes a plurality of first characters and a plurality of second characters,
wherein each of the plurality of first characters is of a first category of video games,
wherein each of the plurality of second characters is of a second category of video games, and
wherein the first category and the second category are different categories.

7. The method of claim 6, wherein the one or more of the video games includes a sports video game.

8. The method of claim 6, wherein the one or more of the video games falls under one of (i) the first category of video games and (ii) the second category of video games.

9. The method of claim 1,
wherein the characters includes a plurality of first characters, a plurality of second characters and a plurality of third characters,
wherein each of the plurality of first characters is of a first video game of a first sport,
wherein each of the plurality of second characters is of a second video game of a second sport,
wherein each of the plurality of third characters is of a third video game of a third sport, and
wherein the first sport, the second sport and the third sport are different sports.

10. The method of claim 9,
wherein the first sport is football,
wherein the second sport is basketball, and
wherein the third sport is baseball.

11. The method of claim 9,
wherein the one or more of the video games includes a fourth video game of a fourth sport, and
wherein the fourth sport is different than each of the first sport, the second sport and the third sport.

12. The method of claim 11, wherein the fourth sport is football.

13. The method of claim 11, wherein the fourth sport is basketball.

14. The method of claim 11, wherein the fourth sport is baseball.

15. A method comprising:
displaying, through a store, information identifying at least a character of a first video game to import into at least a second video game; and
individually selling and/or renting, through the store, the character, separate from the first video game and the second video game, by at least charging on a per character basis.

16. The method of claim 15, wherein the store is an online store.

17. The method of claim 15,
wherein the first video game is of a first category of video games,
wherein the second video game is of a second category of video games, and
wherein the first category and the second category are different categories.

18. The method of claim 15,
wherein the first video game is of a first sport,
wherein the second video game is of a second sport, and
wherein the first sport and the second sport are different sports.

19. A method comprising:
displaying information identifying at least a character and/or roster; and
selling and/or renting the character and/or roster itself to import into a first video game, and separately selling and/or renting the character and/or roster itself to import into a second video game,
wherein the first video game and the second video game have different game titles, and are both playable with the same platform.

20. The method of claim 19, further comprising
downloading the character and/or roster to import into at least one of (i) the first video game and (ii) the second video game.

21. The method of claim 19, wherein (i) the first video game and (ii) the second video game are of different categories of video games.

22. The method of claim 19, wherein (i) the first video game and (ii) the second video game are of different sports.

23. A method comprising:
displaying information identifying at least different athletes of video games of different sports;
sending a request to order a roster to import into one or more of the video games by at least selecting a plurality of the athletes for the roster; and
fulfilling the order for the roster by at least receiving the request for the order.

24. The method of claim 23, wherein the video games of different sports include (i) a football video game, (ii) a basketball video game and (iii) a baseball video game.
